(19) United States
(12) Patent Application Publication
(10) Pub. No.: US 2015/0261693 A1
(43) Pub. Date: Sep. 17, 2015

(54) DYNAMIC STORAGE KEY ASSIGNMENT

(71) Applicant: International Business Machines Corporation, Armonk, NY (US)

(72) Inventors: David F. Craddock, New Paltz, NY (US); Thomas A. Gregg, Highland, NY (US)

(73) Assignee: International Business Machines Corporation, Armonk, NY (US)

(21) Appl. No.: 14/211,168

(22) Filed: Mar. 14, 2014

(51) Int. Cl. G06F 12/14; G06F 12/10; G06F 12/08; G06F 13/40

(52) U.S. Cl. CPC G06F 12/1475; G06F 13/4022; G06F 12/1081; G06F 12/0866; G06F 2212/284; G06F 2212/303; G06F 2212/1052

(57) ABSTRACT

A dynamic storage key assignment is provided. An aspect includes receiving, by a host bridge, a request. An aspect includes determining, by the host bridge, that a dynamic storage key assignment is supported and enabled in association with a memory address space referenced by the request based on a requester identifier or a portion of a peripheral component interconnect address associated with the request. An aspect includes, based on determining that the dynamic storage key assignment is supported and enabled, accessing, by the host bridge, a page included in the memory address space based on a storage key included in the request matching a storage key associated with the page being accessed or an entry in a listing of permitted storage keys for the memory address space.

### BACKGROUND

The present invention relates generally to computing technology, and more specifically, to a dynamic storage key assignment.

Storage keys are traditionally used for controlling access to pages within a memory subsystem. Input/output (I/O) access to this memory has typically had very little flexibility in the selection or allocation of these storage keys, with the storage key protection either being avoided completely or statically assigning a single storage key for all memory accessible by the I/O adapter.

There is a need for a more dynamic allocation of storage keys associated with memory accessible to I/O adapters. Ideally each I/O operation should be able to select a storage key dynamically to provide finer grained protection of operating system (OS) memory.

### SUMMARY

Embodiments include a method, system, and computer program product for providing a dynamic storage key assignment. In an embodiment, a method comprises receiving, by a host bridge, a request. The method comprises determining, by the host bridge, that a dynamic storage key assignment is supported and enabled in association with a memory address space referenced by the request based on a requester identifier or a portion of a peripheral component interconnect address associated with the request. Based on determining that the dynamic storage key assignment is supported and enabled, the method comprises accessing, by the host bridge, a page included in the memory address space based on a storage key included in the request matching a storage key associated with the page being accessed or an entry in a listing of permitted storage keys for the memory address space.

In an embodiment, a computer program product for a dynamic storage key assignment is provided. The computer program product comprises a tangible storage medium readable by a processing circuit and storing instructions for execution by the processing circuit for performing a method. The method comprises receiving, by a host bridge, a request. The method comprises determining, by the host bridge, that a dynamic storage key assignment is supported and enabled in association with a memory address space referenced by the request based on a requester identifier or a portion of a peripheral component interconnect address associated with the request. Based on determining that the dynamic storage key assignment is supported and enabled, the method comprises accessing, by the host bridge, a page included in the memory address space based on a storage key included in the request matching a storage key associated with the page being access or an entry in a listing of permitted storage keys for the memory address space.

In an embodiment, a computer system for a dynamic storage key assignment is provided. The system comprises a memory having computer readable instructions. The system comprises a processor configured to execute the computer readable instructions. The instructions comprise receiving a request. The instructions comprise determining that a dynamic storage key assignment is supported and enabled in association with a memory address space referenced by the request based on a requester identifier or a portion of a peripheral component interconnect address associated with the request. The instructions comprise, based on determining that the dynamic storage key assignment is supported and enabled, accessing a page included in the memory address space based on a storage key included in the request matching a storage key associated with the page being accessed or an entry in a listing of permitted storage keys for the address space.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a computing system environment in accordance with an embodiment;

FIG. 2 depicts a system for providing a dynamic storage key assignment in accordance with an embodiment; and

FIG. 3 depicts a process flow for providing a dynamic storage key assignment in accordance with an embodiment.

### DETAILED DESCRIPTION

In accordance with one or more embodiments, systems, apparatuses, and methods are described that provide a dynamic storage key assignment. In this manner, flexibility is provided in terms of an adapter being able to obtain access to different portions of memory. In some embodiments, an adapter associated with an operating system (OS) may dynamically obtain access to one or more portions of memory based on storage keys. More generally, an adapter may obtain access to portions of memory associated with one or more OSs. Techniques are described for dynamically assigning a storage key for separate input/output (I/O) operations with, e.g., a peripheral component interconnect (PCI) or peripheral component interconnect express (PCIe) subsystem

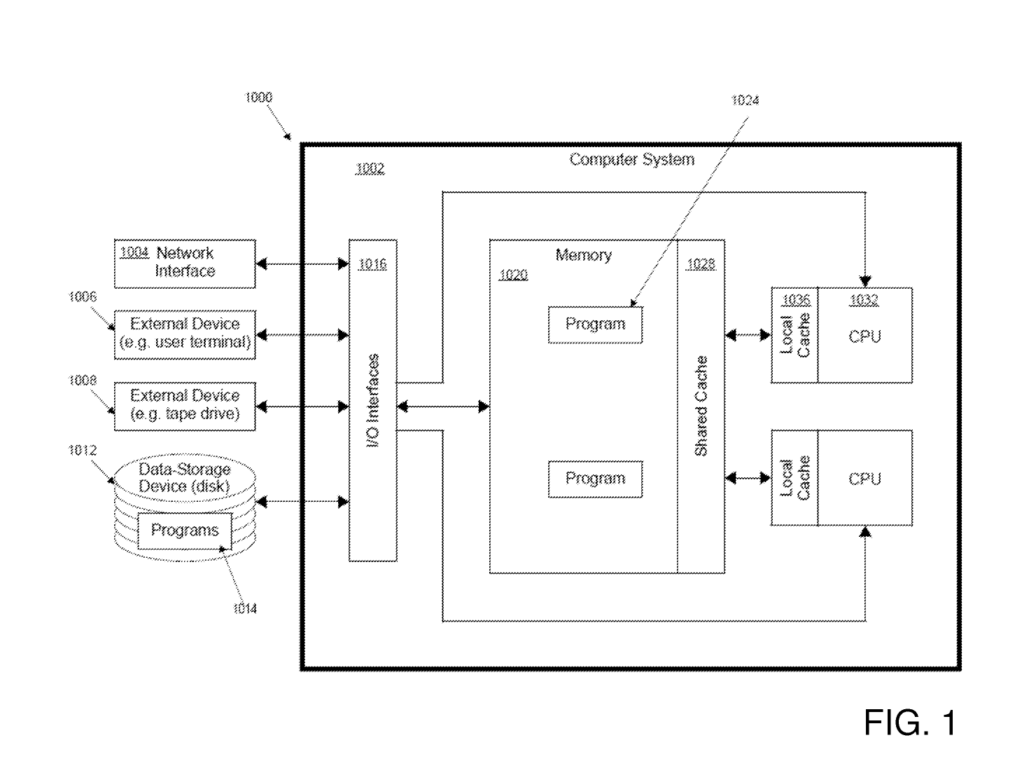

FIG. 1 shows a system 1000 in accordance with one or more embodiments. In particular, the system 1000 includes a computer system 1002. The computer system 1002 may include one or more components or devices, such as one or more I/O interfaces 1016. The I/O interface 1016 may be coupled to one or more processors, such as one or more CPUs 1032. Each of the CPUs 1032 may be associated with one or more caches 1036. The I/O interface 1016 and the caches 1036 may couple to a memory or memory device 1020. The memory device 1020 may store one or more programs 1024. The programs 1024 may be executed to perform one or more methodological acts, such as those described herein. The memory 1020 may be associated with a shared cache 1028. The shared cache 1028 may be accessed by the caches 1036 and/or the CPUs 1032 to store and share, e.g., data.

The computer system 1002/I/O interface 1016 may be coupled to one or more interfaces or devices. For example, a network interface 1004 may be used to provide networking support in connection with one or more networks. An external device 1006 may include one or more devices that may interface to the computer system 1002, such as a user terminal. As yet another example of an external device, a tape drive 1008 may be included. In some embodiments, a storage device 1012 may be included. The storage device 1012 may include one or more disks. The storage device 1012 may be used to store programs 1014 that may optionally be executed by the computer system 1002.

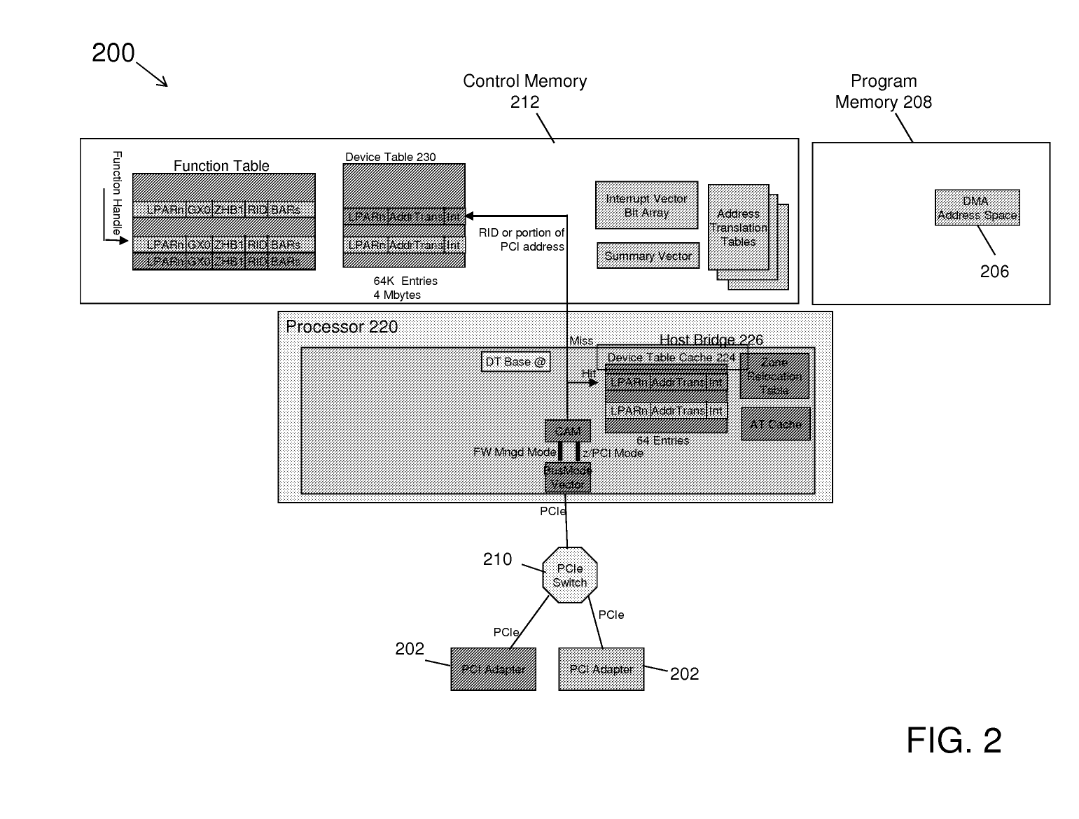

Referring now to FIG. 2, a system 200 is shown. The system 200 may be used to dynamically assign a storage key (e.g., a System z storage key) for one or more I/O operations.

A PCI adapter 202 may request access to a direct memory access (DMA) address space (DMAAS) 206 included in a program memory 208. The DMAAS 206/program memory 208 may include one or more pages. The access request may correspond to one or more of: a read operation, a write operation, or an atomic operation that is a combination of one or more read or write operations. The request may be routed over PCI (or, analogously, over PCIe) to a switch 210, such as PCIe switch.

The PCI request may include or reference a requester identifier (RID), which may be sixteen bits in length. The RID may serve to identify or distinguish the PCI function or PCI adapter 202 issuing the request from other devices, such as other PCI functions or PCI adapters 202.

The request may be forwarded by the switch 210 to a host bridge 226 that may be associated with a processor 220, such as a zProcessor provided by the International Business Machines Corporation. The processor 220 may correspond to one or more of the processors 1032 of FIG. 1 in some embodiments. As a preliminary matter, the RID associated with the request may be used to locate a device table entry (DTE) that may be in a device table cache 224 included in the host bridge 226 to determine if a request has previously been serviced, such that an entry is still present in the cache 224 when the request is received by the host bridge 226. If the entry is present in the cache 224 (a so-called cache “hit”), then access to the DMAAS 206 may be based on the use of the cache entry. Otherwise, if the entry is not present in the cache 224 when the request is received by the host bridge 226 (a so-called cache “miss”), the DTE is fetched from a device table 230 in system memory.

The device table 230 may include a number of entries, each denoted as a device table entry (DTE). For example, the device table 230 may include 64K DTEs and may be 4 Megabytes in size in the embodiment of FIG. 2. Once the DTE is recognized/accessed for the adapter request based on the RID or a portion of the PCI address, the information associated with the DTE may be inserted in the cache 224 to facilitate future cache hits for that DTE.

An example DTE is shown in FIG. 2. The DTE may include a number of fields, such as interrupt-control fields that may facilitate bridging message signaled interruptions from a PCI adapter 202 to an interruption architecture of the processor 220. It may also contain address translation and protection information including a storage key that may be used to determine whether access is permitted to the DMAAS 206.

Upon receiving the request, the host bridge 226 uses the RID or a portion of the PCI address received in the request to locate the DTE associated with the PCI function. Information in this DTE may be used to determine if the PCI function or adapter 202 is authorized to access the DMAAS 206. Such a determination may be based on the characteristics of the DMAAS stored in the DTE, such as a PCI address Base and Limit, read or write access controls, or a storage key. These characteristics are stored in the DTE as part of a registration process. The bounds of the memory address space 206 may be established by a PCI base address field and a PCI limit address fields in the DTE.

If the request issued by the PCI function or adapter 202 is not permitted access based on the controls in the DTE, the request may be denied and the PCI function or adapter 202 might not gain access to the DMA address space 206.

If the request issued by the PCI function or adapter 202 is permitted, then a determination may be made whether a control mode bit or indicator in the DTE indicates that dynamic storage keys are supported and enabled. If the indicator indicates that dynamic storage keys are not supported or enabled then the request may be processed in accordance with conventional techniques in order to support backwards compatibility (e.g., to provide support for legacy platforms). On the other hand, if the indicator indicates that dynamic storage keys are supported and enabled then at least a portion of an address field associated with the request may be examined for storage key purposes.

In accordance with one or more embodiments, an address associated with the request issued by a PCI function or adapter 202 may have one or more bits redefined or repurposed to provide information regarding storage keys. For example, if the address is a 64-bit address, the most significant four bits (e.g., bits 0:3 of bits 0:63) may be redefined so as to represent a storage key. The host bridge 226 may present the storage key to a memory controller (not shown) associated with the memory 208. The controller may compare the storage key included in the request to a listing of permitted storage keys for the DMA space 206 or to the storage key associated with the page being accessed (where the DMA address space 206 may be selected based on other address bits included in the request, potentially subject to any address translation that may be performed by the host bridge). If the storage key provided in the request matches an entry in the listing of permitted storage keys or the specific storage key associated with the page being accessed, the adapter 202 may effectively gain access to the page within the DMA address space 206 for performing an operation. Otherwise, if the storage key provided in the request does not match an entry in the listing of permitted storage keys, the adapter 202 may be denied access to the page within the DMA address space 206.

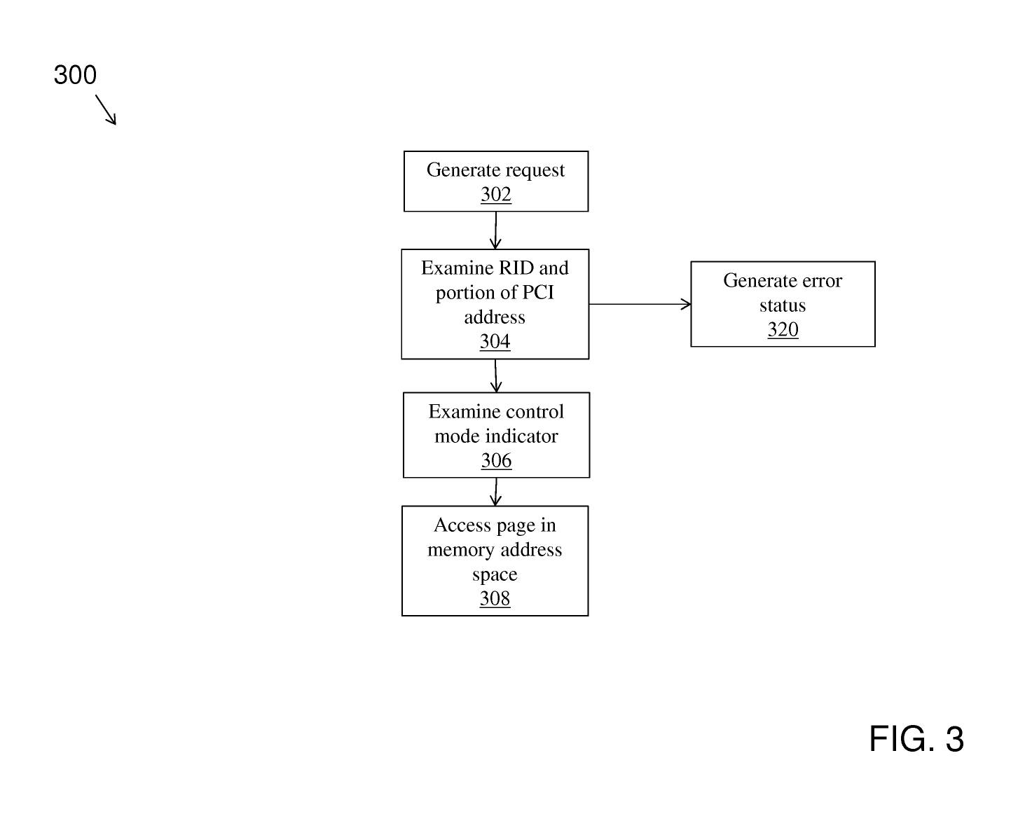

Turning to FIG. 3, a flow chart of a method 300 is shown. The method 300 may be executed by one or more systems, devices, or components, such as those described herein. An execution of the method 300 may serve to provide for a dynamic storage key assignment.

In block 302, a request for memory access may be generated. For example, a PCI adapter (or associated PCI function) may generate the request. The request may include an RID and an address, such as a PCI address. The request may include a specification of one or more read or write operations to perform with respect to a DMA address space. The request may be received by one or more entities, such as a host bridge.

In block 304, the RID and a portion of the PCI address may be examined to determine if the PCI adapter has access rights/permission to the memory address space referenced by the PCI address. If the PCI adapter does not have such access rights, flow may proceed from block 304 to block 320, wherein an error status may be generated. Otherwise, if the PCI function or adapter does have such access rights, flow may proceed from block 304 to block 306.

In block 306, a control mode indicator may be examined to determine if dynamic storage keys are supported and enabled for the adapter/memory interface. If the control mode indicator indicates that dynamic storage keys are not supported or enabled, the request may be processed in accordance with conventional techniques and the method 300 may end (not shown in FIG. 3). Otherwise, if the control mode indicator indicates that dynamic storage keys are supported, flow may proceed from block 306 to block 308.

In block 308, a page in memory address space may be accessed. Such access may be conditioned on a specification of a storage key included in the request matching the storage key associated with the page being accessed or an entry in a list of permitted storage keys associated with the DMAAS.

The method 300 is illustrative. In some embodiments, one or more of the blocks, or a portion thereof, may be optional. In some embodiments, additional blocks or operations not shown may be included. In some embodiments, the blocks may execute in an order or sequence that is different from what is shown in FIG. 3.

Technical effects and benefits include an availability of dynamic storage keys to access memory or a given DMAAS. Unlike conventional techniques wherein a storage key is static and is specified in a device table entry, embodiments of the disclosure include a specification of a storage key in a portion of an address field associated with a PCI adapter request. In this manner, different storage keys may be specified for different operations from a given PCI function or adapter, and flexibility is provided to allow the storage keys, or the meaning of the storage keys, to change over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for a dynamic storage key assignment, the method comprising:
receiving, by a host bridge, a request;
determining, by the host bridge, that a dynamic storage key assignment is supported and enabled in association with a memory address space referenced by the request based on a requester identifier or a portion of a peripheral component interconnect address associated with the request; and
based on determining that the dynamic storage key assignment is supported and enabled, accessing, by the host bridge, a page included in the memory address space based on a storage key included in the request matching a storage key associated with the page being accessed or an entry in a listing of permitted storage keys for the memory address space.

2. The method of claim 1, further comprising:
determining, by the host bridge, that the dynamic storage key assignment is supported and enabled based on one or more control mode indicators associated with the memory address space.

3. The method of claim 1, further comprising:
determining, by the host bridge, that the access to the memory address space referenced by the request is authorized based on determining that access controls within a device table entry permit access.

4. The method of claim 1, wherein the request is forwarded by a switch associated with a peripheral component interconnect adapter.

5. The method of claim 1, wherein the access of the page included in the memory address space is based on an entry stored in a cache.

6. The method of claim 1, wherein the access of the page included in the memory address space is associated with at least one of: a read operation, a write operation, and an atomic operation with respect to the page.

7. The method of claim 1, wherein the storage key included in the request corresponds to a redefinition of one or more peripheral component interconnect address bits.

8. A computer program product for a dynamic storage key assignment, the computer program product comprising:
a tangible storage medium readable by a processing circuit and storing instructions for execution by the processing circuit for performing a method comprising:
receiving, by a host bridge, a request;
determining, by the host bridge, that a dynamic storage key assignment is supported and enabled in association with a memory address space referenced by the request based on a requester identifier or a portion of a peripheral component interconnect address associated with the request; and
based on determining that the dynamic storage key assignment is supported and enabled, accessing, by the host bridge, a page included in the memory address space based on a storage key included in the request matching a storage key associated with the page being access or an entry in a listing of permitted storage keys for the memory address space.

9. The computer program product of claim 8, wherein the method performed by the processing circuit further comprises:
determining, by the host bridge, that the dynamic storage key assignment is supported and enabled based on one or more control mode indicators associated with the memory address space.

10. The computer program product of claim 8, wherein the method performed by the processing circuit further comprises:
determining, by the host bridge, that the access to the memory address space referenced by the request is authorized based on determining that access controls within a device table entry permit access.

11. The computer program product of claim 8, wherein the method performed by the processing circuit further comprises:
receiving, by the host bridge, the request from a switch associated with a peripheral component interconnect adapter.

12. The computer program product of claim 8, wherein the method performed by the processing circuit further comprises:
accessing, by the host bridge, the page included in the memory address space based on determining that an entry associated with the page included in the memory address space is stored in a cache.

13. The computer program product of claim 8, wherein the access of the page included in the memory address space is associated with a read operation with respect to the page.

14. The computer program product of claim 8, wherein the access of the page included in the memory address space is associated with a write operation with respect to the page.

15. The computer program product of claim 8, wherein the storage key included in the request corresponds to a redefinition of one or more address bits.

16. A computer system for a dynamic storage key assignment, the system comprising:
a memory having computer readable instructions; and
a processor configured to execute the computer readable instructions, the instructions comprising:
receiving a request;
determining that a dynamic storage key assignment is supported and enabled in association with a memory address space referenced by the request based on a requester identifier or a portion of a peripheral component interconnect address associated with the request; and
based on determining that the dynamic storage key assignment is supported and enabled, accessing a page included in the memory address space based on a storage key included in the request matching a storage key associated with the page being accessed or an entry in a listing of permitted storage keys for the address space.

17. The computer system of claim 16, wherein the instructions comprise:
determining that the dynamic storage key assignment is supported and enabled based on one or more control mode indicators associated with the memory address space.

18. The computer system of claim 16, wherein the instructions comprise:
determining that the access to the memory address space referenced by the request is authorized based on determining that access controls within a device table entry permit access.

19. The computer system of claim 16, wherein the instructions comprise:
receiving the request from a switch associated with a peripheral component interconnect adapter.

20. The computer system of claim 16, wherein the memory address space is a direct memory access address space, and wherein the instructions comprise:
translating an address included in the request in accessing the page.
